(19) United States
(12) Patent Application Publication
(10) Pub. No.: US 2014/0379840 A1
(43) Pub. Date: Dec. 25, 2014

(54) PREDICTIVE PREFETCHING OF WEB CONTENT

(71) Applicant: Akamai Technologies, Inc., Cambridge, MA (US)

(72) Inventor: Edward T. Dao, San Jose, CA (US)

(73) Assignee: Akamai Technologies, Inc., Cambridge, MA (US)

(21) Appl. No.: 14/311,699

(22) Filed: Jun. 23, 2014

Related U.S. Application Data
(60) Provisional application No. 61/838,792, filed on Jun. 24, 2013.

(51) Int. Cl. H04L 29/08; G06N 5/04

(52) U.S. Cl. CPC H04L 67/2847; G06N 5/04
USPC 709/213; 709/219

(57) ABSTRACT

This disclosure describes systems and methods for predictive prefetching. A server can be modified in accordance with the teachings hereof to predictively prefetch a second object for a client (referred to herein as the dependent object), given a request from the client for a first object (referred to herein as the parent object). When enough information about a parent object request is available, the predictive prefetching techniques disclosed herein can be used to calculate the likelihood that one or more dependent objects might be requested. This enables a server to prefetch them from local or remote storage device, from an origin server, or other source.

### CROSS-REFERENCE TO RELATED APPLICATIONS

This application is based on and claims the benefit of priority of U.S. Application No. 61/838,792, titled “Predictive Prefetching of Web Content” and filed Jun. 24, 2013, the contents of which are hereby incorporated by reference in their entirety.

This patent document contains material which is subject to copyright protection. The copyright owner has no objection to the facsimile reproduction by anyone of the patent document or the patent disclosure, as it appears in Patent and Trademark Office patent files or records, but otherwise reserves all copyright rights whatsoever.

### BACKGROUND

1. Technical Field

The subject matter hereof relates generally to distributed data processing systems, to the delivery of content to users over computer networks, and to the predictive prefetching of content in anticipation of client requests.

2. Brief Description of the Related Art

In the client-server model for delivery of content, a client typically makes a request for content to a server and the server responds with the requested content. For example, a client (such as an end user web browser application running on an appropriate hardware device) might send an HTTP request to the server specifying the HTTP ‘GET’ method and identifying a particular web object that is desired, such as an HTML file. The server responds with the HTML. The HTML often contains embedded references to other objects, such as images, scripts, CSS, other HTML documents, and the like, and so then the client requests these from the server. Many such requests may be necessary to fetch all of the content embedded in a typical web page.

During the process described above, the server is often waiting for the client to request the next object. To accelerate the process, it is known to have the server prefetch certain objects so that they are ready to be served to the client when the client's request for the object arrives. For example, if the server has the content locally, it can prefetch the content from disk to memory. If the server is acting as a forward or reverse proxy server, it can fetch the content from an origin server or other source. The server may be part of a distributed infrastructure such as a content delivery network (CDN), in which case the server, typically a caching proxy server, might fetch the content from other resources internal or external to the CDN platform.

U.S. Patent Publication No. 2007/0156845, the contents of which are hereby incorporated by reference, describes technology in which a CDN server is configured to provide content prefetching (among other content handling features). When prefetching is enabled, the CDN server retrieves objects embedded in pages at the same time it serves the page to the browser, rather than waiting for the client's request for those objects. This technique can significantly decrease the overall rendering time of the page and improve the user experience of a web site. Using a set of metadata tags that control and configure CDN server operation for a given set of content, prefetching can be applied to either cacheable or uncacheable content. When prefetching is used for cacheable content, and the object to be prefetched is already in cache, the object can be moved from disk into memory so that it is ready to be served. When prefetching is used for uncacheable content, preferably the retrieved objects are uniquely associated with the client browser request that triggered the prefetch so that these objects cannot be served to a different end user. Prefetching can be combined with tiered distribution and other server configuration options to further improve the speed of delivery and/or to protect an origin server from bursts of prefetching requests.

To facilitate prefetching, it is known to try to predict the next client request(s), given an initial request and previous request patterns. Such techniques are sometimes referred to as “predictive prefetching.” However, current methods of prediction leave room for improvement.

The teachings hereof address the need for improved predictive prefetching. The teachings hereof provide a variety of benefits and advantages that will become apparent to those skilled in the art in view of this disclosure.

### BRIEF DESCRIPTION OF THE DRAWINGS

The invention will be more fully understood from the following detailed description taken in conjunction with the accompanying drawings, in which:

FIG. 1 is a flow diagram illustrating a predictive prefetching process, in one embodiment;

FIG. 2 is a diagram illustrating relationships between parent objects and dependent objects;

FIG. 3 is a logical diagram illustrating components in an embodiment of a predictive prefetch system;

FIG. 4 is a diagram illustrating tables for tracking counts for request parameters, in one embodiment;

FIG. 5A is a table reflecting a set of content requests, in one embodiment;

FIG. 5B is a set of three event block tables generated from the content requests shown in FIG. 5A, in one embodiment;

FIG. 5C is a diagram illustrating tables for tracking counts for request parameters, in one embodiment;

FIG. 6 is a schematic diagram illustrating one embodiment of a known distributed computer system configured as a content delivery network (CDN);

FIG. 7 is a schematic diagram illustrating one embodiment of a machine on which a CDN server shown in FIG. 6 can be implemented; and,

FIG. 8 is a block diagram illustrating hardware in a computer system that may be used to implement the teachings hereof.

### DETAILED DESCRIPTION

The following description sets forth embodiments of the invention to provide an overall understanding of the principles of the structure, function, manufacture, and use of the methods and apparatus disclosed herein. The systems, methods and apparatus described herein and illustrated in the accompanying drawings are non-limiting examples; the claims alone define the scope of protection that is sought. The features described or illustrated in connection with one exemplary embodiment may be combined with the features of other embodiments. Such modifications and variations are intended to be included within the scope of the present invention. All patents, publications and references cited herein are expressly incorporated herein by reference in their entirety. Throughout this disclosure, the term “e.g.” is used to refer to the non-limiting phrase “for example.”

A conventional server can be modified in accordance with the teachings hereof to predictively prefetch a second object for a client (referred to herein as the dependent object), given a previous request from the client for a first object (referred to herein as the parent object). When enough information about a parent object request is available, the predictive prefetching techniques disclosed herein can be used to calculate the likelihood that one or more dependent objects might be requested. This enables a server to prefetch them from local or remote storage device, from an origin server, or other source. The dependent objects are preferably prefetched at the same time that the server fetches the parent object or during the time in between the client's request for the parent object request and the anticipated request for a dependent object. If and when the client makes a request for a dependent object that was prefetched, the server can serve it more quickly, accelerating the delivery process and web page loading.

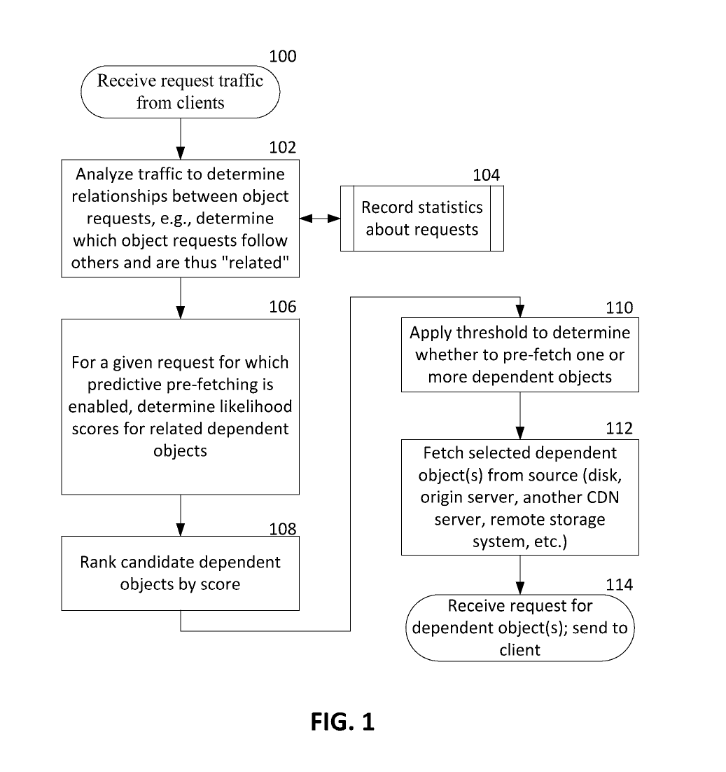

FIG. 1 generally illustrates a predictive prefetching workflow, in one embodiment. The workflow begins with a server receiving client request traffic, such as HTTP requests for content (100). The server notes the dependent object requests that follow a particular parent object request (102) and records statistics (104) about these occurrences, including information about the requests and the objects themselves (such as URLs, the request header fields and values, etc.). This collection of data may be bounded in a window of time, for example such that only dependent objects requests following a parent object request within a certain configurable time ‘T’ are captured. As time passes, the data from multiple windows can be aggregated and stored. A variety of storage approaches may be used; examples are described later. Eventually, old data may be evicted from the store.

At 106, given a particular request for a parent object that is received, a server can make a prediction by calculating the likelihood of a receiving a subsequent request for one or more dependent object(s).

Various implementations for making the prediction will be described in more detail below. As one example, however, a server can determine the probability of a request for a particular dependent object given the request for the parent object's URL or portions thereof. The server can also examine parameters in the client's request, such as request headers, query parameters, and the like. Each parameter of the parent request may affect the overall likelihood score. The marginal effect of each of these parameters can be calculated and used to adjust the score for the dependent object either positively or negatively.

To illustrate in the context of an HTTP request, assume a server receives a GET request for a parent object at URL_{—}1. The server may know from prior requests that a given dependent object at URL_{—}2 is requested ‘N’ percent of the time shortly following a request for the parent object at URL_{—}1. Further, the server may extract certain parameters from the GET request, such as HTTP request header fields and values, URL query parameters, or others. Preferably, the server can determine the marginal effect of each parameter as an independent event, and take them into account in determining a final probability score for the dependent object (e.g., by summing the marginal effects).

The score for a particular dependent object can be used to rank the likelihood of a particular dependent object request, e.g., comparing it to other potential dependent objects and/or comparing it to a threshold level which defines a minimum confidence level for which prefetching is permitted to occur. This is illustrated in FIG. 1 at 108, 110. The threshold level may be related to a desired accuracy rate and/or a desire to minimize cost of bad predictions. The criteria for actually prefetching one or more dependent objects may vary (e.g., the approach could be to fetch all dependent objects exceeding a threshold, to fetch only the highest scoring dependent object, or otherwise).

At 112, the server prefetches the selected dependent objects. As noted above, prefetching may take many forms, such as prefetching from disk to memory, from another server to the prefetching server, or otherwise. The teachings hereof are not limited to any particular prefetching source and destination.

After prefetching, the server waits for a request for the prefetched object from the client; if and when that request is received, the server already has the object ready and is able to serve the prefetched object with reduced latency, as illustrated by 114 in FIG. 1.

With the foregoing by way of introduction, more detailed embodiments are now described.

Parent and Dependent Objects

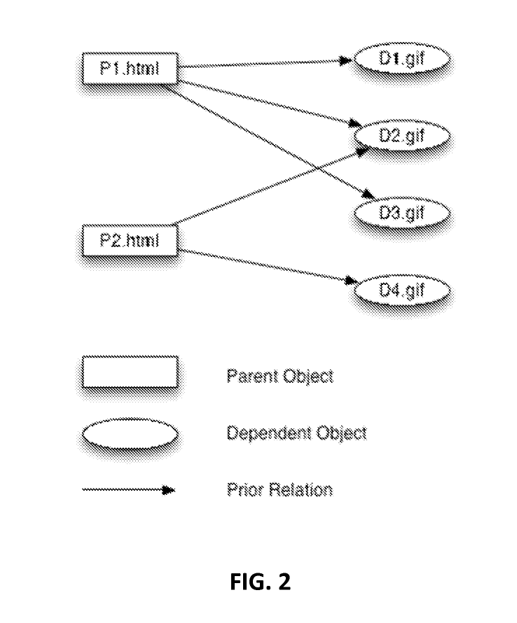

FIG. 2 illustrates relationships between exemplary parent objects and dependent objects. For descriptive purposes, the term ‘parent object’ as used herein generally refers to an object (such as an HTML object P1, as shown in FIG. 2) for which predictive prefetching is applicable or enabled. The term ‘dependent object’ generally refers to an object that is requested following a request for a parent object, preferably although not necessarily within a certain event window. The prior relation is the observed relationship between parent object and dependent object that occurs, again preferably within the same event window. In some implementations, the prior relation may be established or observed by examining the URL referrer header in a request for a dependent object. Put another way, the URL referrer header for the dependent object may contain a URL pointing to the parent object, indicating that the parent object had led to the dependent object. In other implementations, the prior relation may be established by tracking a client's activity in a stateful way, potentially time-bounded, and observing that one request follows another.

As noted, FIG. 2 illustrates some examples of parent objects (the HTML objects P1 and P2) and dependent objects (images D1-D4, which were perhaps embedded on the web pages defined by P1 and P2).

Those skilled in the art will recognize that parent objects are not necessarily HTML files and dependent objects are not necessarily objects referenced in embedded links in a parent HTML page. Parent and dependent objects might be two HTML pages which are observed to follow one after the other due to website browsing patterns, for example. The semantic behind the sequence of object requests is not limiting to the teachings hereof.

System Overview

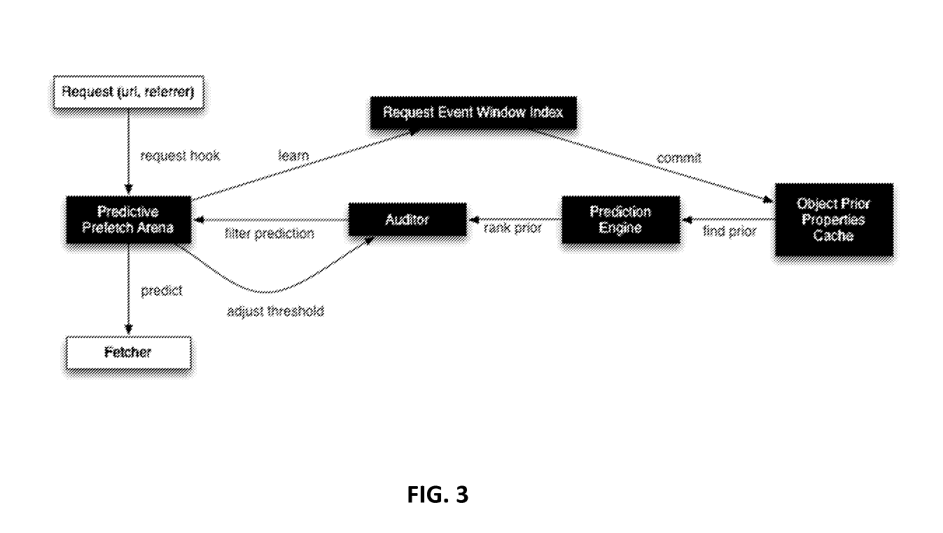

FIG. 3 illustrates an embodiment of a predictive prefetch (PPF) system at a logical level. In this embodiment, the system ingests parent request parameters and prefetches dependent objects based on prior observations of (similar) requests. Advantageously, the system does not need to wait for the content of the parent request to be present and parsed in order to prefetch. The system can provide various options on what to prefetch. For example, in this implementation, the system targets and prefetches only quickly-triggered dependent objects, i.e., those dependent objects that are followed by parent object within a defined and relatively short time window.

Preferably, the PPF system runs within or as an adjunct to an existing server implementation, e.g., a web server, HTTP proxy or other intermediary. It should be assumed that references below to requests are requests received at the server from clients, and that the system has access and visibility into those request messages.

Internally, the processes are split into three main actions: learning, predicting, and adjusting.

Learning

Learning is represented by the ‘request hook’, ‘learn’ and ‘commit’ flow of arrows in FIG. 3. Learning is the act of capturing and representing prior data into a structure. The system captures dependent object requests if and only if it is within its parent request event window, in this embodiment. After the parent event window expires, the system stores the information captured during that window in the Object Prior Property Cache (OPPC). This is indicated in FIG. 3 by the Predictive Prefetch Arena obtaining a request (URL, referrer), capturing (learning) data from that request into a data structure called “Request Event Window Index”, the contents of which are periodically committed to the OPPC.

Predicting

Predicting is represented by the ‘find prior’, ‘rank prior’, ‘filter prediction’, and ‘predict’ flow of arrows in FIG. 3. Using the request parameters, the system's Prediction Engine searches the OPPC for previous records and calculates a likelihood score for each dependent object seen. More details about how to calculate a likelihood score are discussed later.

Adjustment/Auditing

Adjustment/Auditing is represented by the adjust threshold arrow in FIG. 3. For each prediction made, an audit process (the “Auditor” in FIG. 3) verifies whether the prediction was correct, e.g., by determining whether a received dependent object request matches the prediction within a time window. If no request matching a prediction is received, the prediction is marked as a bad prediction, and the prior records in the OPPC can be updated accordingly. The Auditor can also calculate the overall system accuracy and adjust the threshold of what minimum likelihood score must be reached before prefetching is allowed, in order for the system accuracy to hit a certain target value, which may be specified by a user of the system (e.g., by a content provider and/or an operator of the server).

Once the Auditor filters the predictions to capture only the ones that pass the threshold and/or meet other prediction criteria, the prediction can be reported to the Predictive Prefetch Arena to implement the prediction by making the request to a source for the dependent object (the prefetch action). In this embodiment, the Predictive Prefetch Arena utilizes a “Fetcher” component to make this request.

Detailed Design & Operation

Request Event Window Index

This is preferably a short-lived parent object index that will evict its object within a window of time, the size of which is preferably configurable. For each received request, the system searches in this index for the URL specified in the URL referrer header, which points to the parent object URL. Upon finding a match, the system attaches the dependent object request to the record for the parent object request. Thus the parent object request record is connected to records of requests for dependent objects that followed from the parent object request within the event time window.

At the end of the window, the parent object request record is evicted from this index with dependent object request record(s) attached and committed into the Object Prior Property Cache. The index thus ensures the system captures only prior relationship data, namely that in which the parent and dependent object requests happened within the time window. Dependent object requests outside its parent event window will not be captured and learned.

In other embodiments, the teachings hereof can be employed without limiting the capture of data to a particular time window.

Object Prior Property Cache (OPPC)

The OPPC is preferably a key-value map of previously observed parent request records and related dependent request records. In one embodiment it may be thought of as an aggregate of the information emitted over time from the Request Event Window Index. This data structure has relevant data to calculate likelihood of a dependent object request given parent object request parameters.

Preferably, the OPPC keeps state both for cacheable and uncacheable objects. This enables making predictions even for uncacheable parent objects. The underlying design assumption in this approach is that variants of uncacheable pages under the same parent object may have a predictable overlap of dependent objects.

The OPPC stores information about the parent and dependent objects and the requests for them, such as the following:
A count of the number of times the object has been requested
Tables with information about the parent object and parent object request, including:
   The parent object URL
   Request parameter counter table (providing a count of the number of times that request parameters have appeared in requests, described in more detail below)
Tables with information about the dependent object and dependent object request
   The dependent object URL
   A count of the number of times that the dependent object has been requested after the parent
   Request parameter counter table

In some implementations, the collection of prior relationship data may be limited in size, e.g., due to memory limitations. The limit can be set to be slightly higher than the limit of the number of dependent objects for which a parent object can lead to prefetching. Both of these properties are preferably configurable.

Request Parameter Counter Table

This table keeps count of parameters observed in the parent request. In the HTTP context, the parameters represent information in the client request that may affect the likelihood score. Examples of such parameters include the requested URL and components thereof (e.g., protocol, hostname, path, query string, fragment for a URL in the form of <protocol>://<hostname>/<path><query><fragment>). Further examples of parameters include a key/value query portion of the requested URL, a request header field name/value (including in particular the user-agent request header), a cookie name/value, a request method, and potentially some portion of, or value found in, the request body. In some cases, the server may reformat or manipulate the parameter values from those observed in the parent request as they are ingested. For example, the server may store the user agent request header field with a name of “user-agent” and a value equal to a hash of the user-agent string or a client device identifier determined based on the original string, rather than the original user-agent string itself. Alternatively, the server may create parameters based on information in the request—for example, given the IP address of the requesting client, the server can determine a geographic location (e.g., country or region identifier) for the client and append that information to the request as a parameter when storing the request record. Preferably such a process can be performed when a request is initially analyzed as part of the Request Event Window Index process.

In one embodiment, OPPC keeps track of parent request parameters for each parent object and for each observed related dependent object. For the related dependent objects, the table represents the count of the parent URL request and request parameters that leads to this dependent object being requested.

This parameter information helps the system's predictor to calculate the likelihood of a dependent object request, given a set of parent request parameters. The presence of such parameters in a parent request can be an important factor to take into account when calculating the likelihood of a request for a particular dependent object.

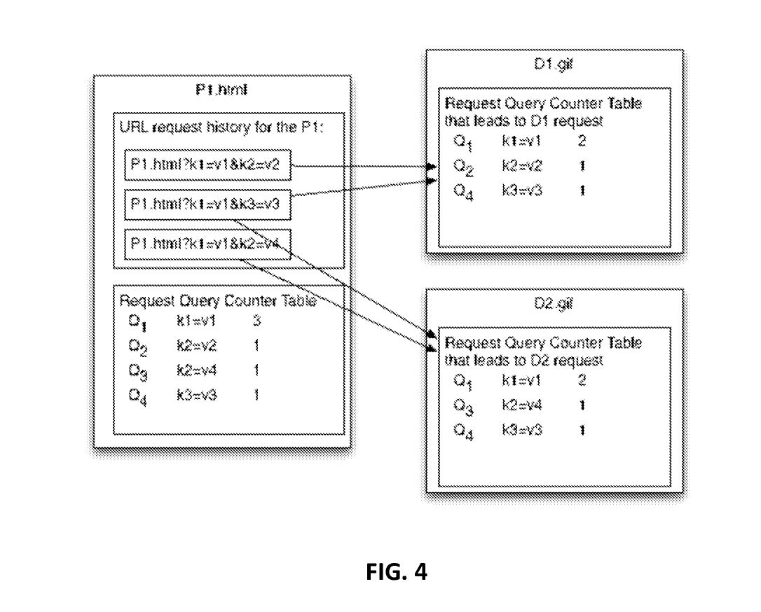

FIG. 4 provides an example of request parameter counter tables in the OPPC for a parent object P1.html and two dependent objects D1.gif and D2.gif. In this example, the parent request parameters tables show URL query key/values. (The tables can easily be extended to capture statistics for other parameters as described above.) The table for P1.html illustrates three queries and below them a table with counts indicating the frequency with which certain key-value pairs occur. The tables for dependent objects D1.gif and D2.gif include counts indicating the frequency with which certain key-value pairs occur in requests that preceded requests for the given dependent object.

Updating the OPPC

As mentioned above, the OPPC tables are updated using a parent object event window block emitted from the Request Event Window Index process. Each event window block can contain the full parent URL request record and records for dependent objects requested within a fixed time window since the parent requested. Dependent objects are linked to the parent object event window block by examining the referrer header. The OPPC update adds a record for the parent object if none existed. If the parent object record already exists, the data in the OPPC is incremented accordingly.

For illustrative purposes, below is pseudo-code for updating the OPPC:

```
Update OPPC:
    Add or update parent object
    let u := parent request parameters
    find u in OPPC by url host and path
    if found
        increment request count
    else
        add new parent object into OPPC set request count
    end if
    parse u and increment parameters counter table
let p := parent object prior record in OPPC
Add or update prior relation to dependent object
    for each d in list of dependent object request in
    event window block
      find d in p
        if found
            increment relation request count of d
            parse u and increment parameters counter
        table of d
        else
            add new prior relation into p
            set relation request count of the new prior
            parse u and increment parameters counter
            table of the new prior
        end if
    end for each
```

Invalidation

Note that in the context of a caching proxy server, the OPPC records related to a given HTML file do not need to be automatically invalidated when the cache entry for that object is released or evicted. This is because the OPPC keeps state about dynamic objects, which are generally not cached, but which may lead to dependent objects that can be prefetched. Hence, the lifetime of an OPPC record may span longer than the lifetime of a given object, and one OPPC record can describe a whole class of distinct objects. In this way, similarities in dependent objects of dynamic objects can be exploited and prefetched.

Prediction Engine

In one embodiment, the Prediction Engine calculates the likelihood of a dependent object request, given a request for a parent object and parameters from the parent object request. Preferably it also provides a likelihood score for other dependent objects associated with that parent object. It is the job of the Auditor to provide a score threshold that must be met before prefetching a dependent object.

A variety of algorithms can be used to calculate the probabilities using the system and the data model presented above. Presented below are two examples. The first is referred to as the Aggregate of Marginal Likelihood approach. For a parent object request parameters U and a dependent object request event D, the likelihood score of D given U is:

$$p ( D \vert P ⋂ {Q}_{1} ⋂ … ⋂ {Q}_{n} ) \approx \frac{{\sum }_{i = 0}^{n} Δ p ( D \vert {Q}_{i} )}{n} + p ( D \vert P )$$

$$and$$

$$Δ p ( D \vert {Q}_{i} ) = p ( D \vert P ⋂ {Q}_{i} ) - p ( D \vert P )$$

$$and$$

$$p ( D \vert P ⋂ {Q}_{i} ) = \frac{p ( P ⋂ {Q}_{i} \vert D ) p ( D \vert P )}{p ( P ⋂ {Q}_{i} )}$$

where:
P is the URL of parent request U
Q₁, . . . , Qₙ is the a unique parameter of the parent request U
Δp(D|Qᵢ) is the marginal affect that Qᵢ has on the likelihood score of D
P(D|P) is the prior probability of D given that the referrer URL is P
p(P∩Qᵢ|D) is the probability that the referrer header has path P and Qᵢ in request D

Here, the likelihood of a dependent object request given the request for the parent object with URL P is calculated as a “base” score. (In this implementation, the URL's protocol, hostname and path are used for P, but the query and fragment are excluded, i.e., the absolute URL minus the query and fragment parts.) Next, the marginal effect of each parent request parameter Q is calculated and used to adjust the base score, positively or negatively. The request parameters Q are generally parameters other than the URL components taken into account in P when calculating the base score—again, examples of Q include information in the request headers, the query name/value pairs, cookies, etc., as previously described.

Thus, each parameter Q of the parent request may affect the overall likelihood score, either positively or negatively. If we add all the marginal effects that a parent request parameter has on the likelihood score as though it each parameter were an independent event, the total we get is a representative number that can be used to rank likelihood of dependent object request.

A second approach is to use Bayes formula to calculate likelihood from a prior given sample, as follows:

$$p ( D \vert P ⋂ {Q}_{1} ⋂ … ⋂ {Q}_{n} ) = p ( P \vert D ) \times {\prod }_{i = 1}^{n} \frac{p ( P ⋂ {Q}_{i} \vert D )}{p ( P ⋂ {Q}_{i} )}$$

This approach does have potential pitfalls which should be taken into consideration:
The circumstance that P(P∩Qᵢ|D)=0. Laplace smoothing can be used to solve this problem.
Floating point arithmetic underflow arising from the fact that the equation invokes multiplication of many small numbers between 0 and 1.

It should be understood that either the Bayes approach or the Aggregate of Marginal Likelihood approach can be used to implement the teachings hereof, though they differ in terms of computational efficiency and accuracy.

Auditor

Continuing with the system embodiment shown in FIG. 3, the Auditor calculates the ratio of total number of good predictive prefetch to the total of predictive prefetch to give the accuracy of the predictive prefetching system:

$$accuracy = \frac{predictive prefetch hit}{predictive prefetch}$$

Preferably, the Auditor adjusts the likelihood score threshold to aim the accuracy toward a targeted goal. The goal is typically user-configurable and may be configured using the metadata system described below when the teachings hereof are employed in the context of a CDN.

As mentioned earlier, the Auditor may mark a particular prediction as ‘bad’—for example this is done if no request for the predicted dependent object arrives within a particular time period following the request for the parent object. In that case, the Auditor modifies the dependent object's records so that some amount N is deducted from its likelihood score, making it less likely to be selected for prefetching by the system in the future. Alternatively, the Auditor may examine the parent object's score threshold and if a particular parent object is generating an excessive number of bad predictions, the Auditor raises the score threshold for that parent object, making it less likely for the system to prefetch objects given that parent object. In effect, the parent object is treated as a parent object for which it is more difficult to make predictions.

### Prefetching Example

For simplicity, the following example illustrates the prediction process only with the URL and the query parameters of the parent request. Other parameters such as request headers could be used alternatively or in addition in a like manner to the query parameters (for example, k1 would represent a request header field name from the parent object request, and v1 would represent that request header field's value, and so on).

Further, in the Figures, the URL has been shown without the protocol and hostname for convenience and simplicity; assume that the protocol and hostname for all URLs are http://www.example.com.

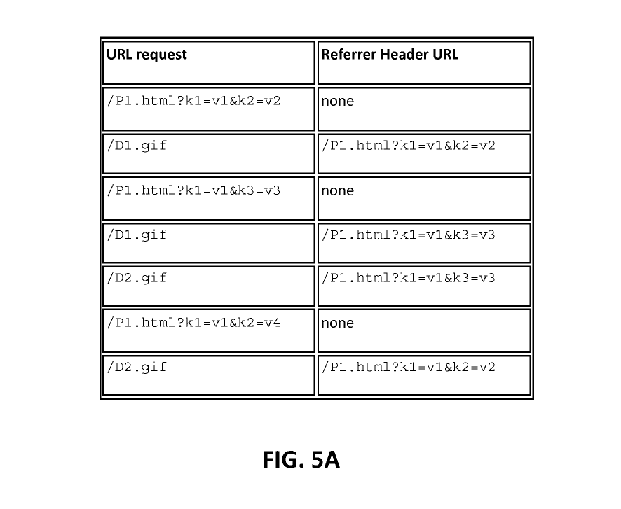

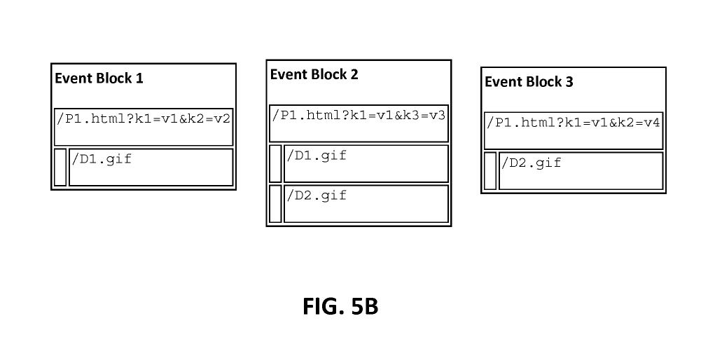

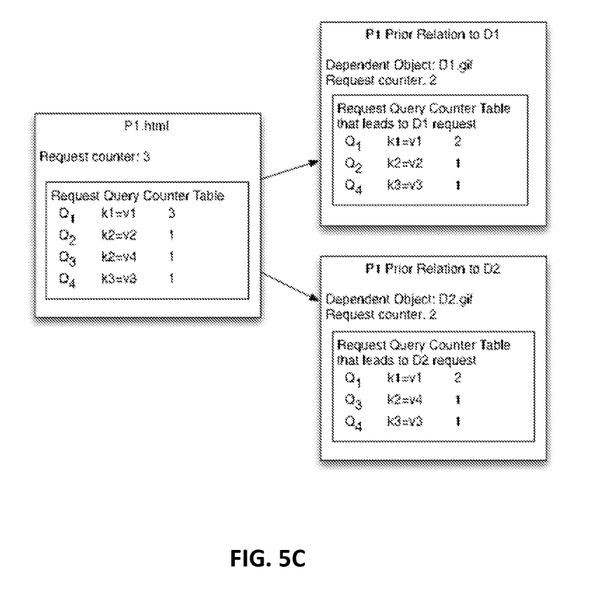

Assume a set of requests for content as shown in FIG. 5A. The above series of requests are broken down into three event blocks in the Request Event Window Index, as shown in FIG. 5B. After inserting these three event blocks into the OPPC, the OPPC will look as illustrated in FIG. 5C.

With reference to FIG. 5C, the likelihood score of a request for dependent object /D1.gif given a parent request for /P1.html?k1=v1&k3=v3&k2=v2 can be determined as follows:

$$\begin{matrix}p ( D 1 \vert P ⋂ {Q}_{i} ) = \frac{p ( P ⋂ {Q}_{1} \vert D 1 ) p ( D 1 \vert P )}{p ( P ⋂ {Q}_{1} )} = \frac{1 \times \frac{2}{3}}{1} = \frac{2}{3} \\ p ( D 1 \vert P ⋂ {Q}_{2} ) = \frac{p ( P ⋂ {Q}_{2} \vert D 1 ) p ( D 1 \vert P )}{p ( P ⋂ {Q}_{2} )} = \frac{\frac{1}{2} \times \frac{2}{3}}{\frac{1}{3}} = 1 \\ p ( D 1 \vert P ⋂ {Q}_{4} ) = \frac{p ( P ⋂ {Q}_{4} \vert D 1 ) p ( D 1 \vert P )}{p ( P ⋂ {Q}_{4} )} = \frac{\frac{1}{2} \times \frac{2}{3}}{\frac{1}{3}} = 1 \\ Δ p ( D 1 \vert P ⋂ {Q}_{1} ) = p ( D \vert P ⋂ {Q}_{1} ) - p ( D 1 \vert P ) = \frac{2}{3} - \frac{2}{3} = 0 \\ Δ p ( D 1 \vert P ⋂ {Q}_{2} ) = p ( D \vert P ⋂ {Q}_{2} ) - p ( D 1 \vert P ) = 1 - \frac{2}{3} = \frac{1}{3} \\ Δ p ( D 1 \vert P ⋂ {Q}_{4} ) = p ( D \vert P ⋂ {Q}_{4} ) - p ( D 1 \vert P ) = 1 - \frac{2}{3} = \frac{1}{3} \\ \begin{matrix}p ( D \vert P ⋂ {Q}_{1} ⋂ … ⋂ {Q}_{n} ) \approx \frac{{\sum }_{i = 0}^{n} Δ p ( D \vert {Q}_{i} )}{n} + p ( D \vert P ) \\ = \frac{0 + \frac{1}{3} + \frac{1}{3}}{3} + \frac{2}{3} = 889\end{matrix}\end{matrix}$$

As described earlier, the Auditor can compare this score to a minimum score threshold, to determine whether to prefetch D1.

Note that in some implementations, the score might be compared to scores for other dependent objects (such as D2). The trigger for prefetching can be configured to work in many different ways other than or addition to the threshold determination (e.g., prefetching can be performed for the highest scoring dependent object, highest-scoring N dependent objects, highest scoring object(s) exceeding a threshold, all objects exceeding a threshold, etc.).

Use with Content Delivery Network

The predictive prefetching system may be implemented as an application, module, or component on a server in a distributed computing platform such as a content delivery network (CDN) operated and managed by a service provider. In such a CDN, a service provider typically provides the content delivery service on behalf of multiple third party tenants (e.g., content providers) who share the computing infrastructure. The “distributed system” of this type is typically a collection of autonomous computers linked by a network or networks, together with the software, systems, protocols and techniques designed to facilitate various services, such as content delivery or the support of outsourced site infrastructure. The infrastructure is generally used for the storage, caching, or transmission of content—such as web pages, streaming media and applications—on behalf of such content providers or other tenants. The platform may also provide ancillary technologies used therewith including, without limitation, DNS query handling, provisioning, data monitoring and reporting, content targeting, personalization, and business intelligence. The CDN processes may be located at nodes that are publicly-routable on the Internet, within or adjacent nodes that are located in mobile networks, in or adjacent enterprise-based private networks, or in any combination thereof

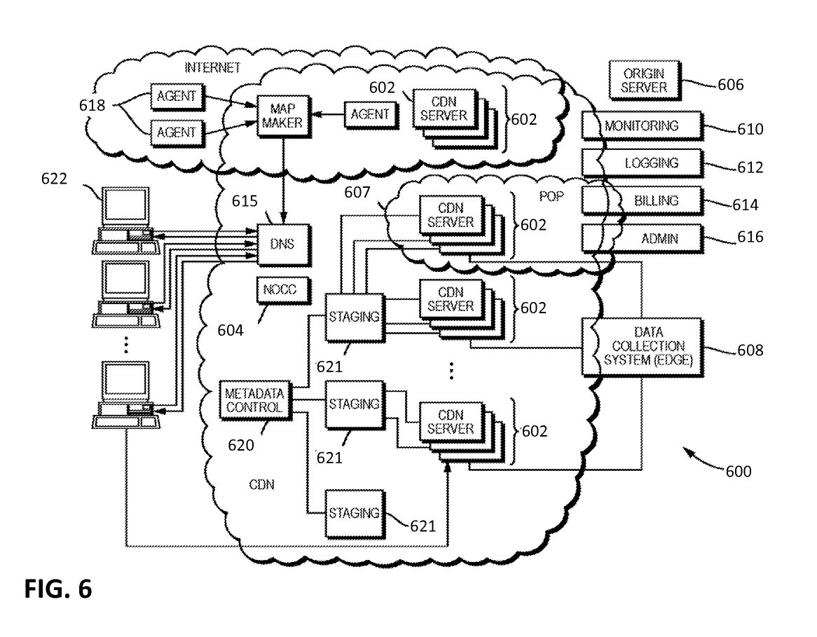

FIG. 6 illustrates a distributed computer system 600 is configured as a content delivery network (CDN) and with set of machines 602 distributed around the Internet. Typically, most of the machines are servers and many are located near the edge of the Internet, i.e., at or adjacent end user access networks. A network operations command center (NOCC) 604 may be used to administer and manage operations of the various machines in the system. Third party sites affiliated with content providers, such as origin site 606, offload delivery of content (e.g., HTML or other markup language files, embedded page objects, streaming media, software downloads, and the like) to the distributed computer system 600 and, in particular, to the CDN servers (which are sometimes referred to as content servers, or sometimes as “edge” servers in light of the possibility that they are near an “edge” of the Internet). Such servers may be grouped together into a point of presence (POP) 607.

Although not shown in detail in FIG. 6, the distributed computer system may also include other infrastructure, such as a distributed data collection system 608 that collects usage and other data from the CDN servers, aggregates that data across a region or set of regions, and passes that data to other back-end systems 610, 612, 614 and 616 to facilitate monitoring, logging, alerts, billing, management and other operational and administrative functions. Distributed network agents 618 monitor the network as well as the server loads and provide network, traffic and load data to a DNS query handling mechanism 615, which is authoritative for content domains being managed by the CDN. A distributed data transport mechanism 620 may be used to distribute control information referred to as ‘metadata’ to the CDN servers (e.g., metadata to manage content, to facilitate load balancing, and the like).

In a typical operation, a content provider identifies a content provider domain or sub-domain that it desires to have served by the CDN. The CDN service provider associates (e.g., via a canonical name, or CNAME, or other aliasing technique) the content provider domain with a CDN hostname, and the CDN provider then provides that CDN hostname to the content provider. When a DNS query to the content provider domain or sub-domain is received at the content provider's domain name servers, those servers respond by returning the CDN hostname. That network hostname points to the CDN, and that hostname is then resolved through the CDN name service. To that end, the CDN name service returns one or more IP addresses. The requesting client application (e.g., browser) of an end-user 622 then makes a content request (e.g., via HTTP or HTTPS) to a CDN server associated with the IP address. The request includes a host header that includes the original content provider domain or sub-domain. Upon receipt of the request with the host header, the CDN server checks its configuration file to determine whether the content domain or sub-domain requested is actually being handled by the CDN. If so, the CDN server applies its content handling rules and directives for that domain or sub-domain as specified in the configuration. As noted, these content handling rules and directives may be located within an XML-based “metadata” configuration file. In general, the CDN servers respond to the client requests, for example by obtaining requested content from a local cache, from another CDN server, from the origin server 606, or other source, applying the appropriate configurations in the process.

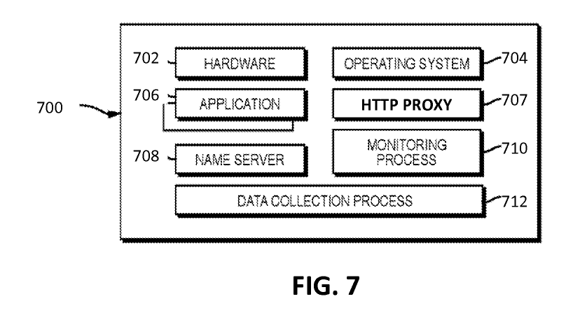

As illustrated in FIG. 7, a given machine 700 in the CDN comprises commodity hardware (e.g., a microprocessor) 702 running an operating system kernel (such as Linux® or variant) 704 that supports one or more applications 706. To facilitate content delivery services, for example, given machines typically run a set of applications, such as an HTTP proxy 707, a name server 708, a local monitoring process 710, a distributed data collection process 712, and the like. The HTTP proxy 707 typically includes a manager process for managing a cache and delivery of content from the machine. For streaming media, the machine typically includes one or more media servers.

As mentioned above, a given CDN server shown in FIG. 6 may be configured to provide one or more extended content delivery features, preferably on a domain-specific, content-provider-specific basis, preferably using configuration files that are distributed to the CDN servers using a configuration system. A given configuration file preferably is XML-based and includes a set of content handling rules and directives that facilitate one or more advanced content handling features. The configuration file may be delivered to the CDN server via the data transport mechanism. U.S. Pat. No. 7,240,100, the contents of which are hereby incorporated by reference, describe a useful infrastructure for delivering and managing CDN server content control information and this and other control information (sometimes referred to as metadata) can be provisioned by the CDN service provider itself, or (via an extranet or the like) the content provider customer who operates the origin server.

In one implementation, a predictive prefetching system in accordance with the teachings hereof may be implemented within the HTTP proxy 707, or in another application that communicates with the HTTP proxy 707 running on the CDN server machine 700.

Also, a predictive prefetching system in accordance with the teachings hereof may be configured using the above-described metadata configuration system. The system may be enabled or disabled on a per-content provider, per-website basis, and the request parameters that will affect the operation of the prefetching system may be independently configured.

For example, metadata relevant to the prefetching system can include the following:

| Name | Tag/Node/Separator | Description |
|---|---|---|
| services: predictive- | separator | |
| prefetching | | |
| status | tag | Type: Flag. Activate predictive |
| | | prefetching for a request. |
| max-dependent-object- | tag | Type: Integer. The maximum number of |
| cached-per-page | | dependent objects that will be cached for |
| | | a page. |
| max-prefetches-per- | tag | Type: Integer. The maximum number of |
| page | | dependent objects to predictively |
| | | prefetch for a page hit. The default 0 |
| | | means the same limit as max-dependent- |
| | | object-cached-per-page. Prefetching |
| | | might prefetch fewer than this many |
| | | objects depending on the ranking |
| | | threshold. |
| target-accuracy | tag | Type: Integer. An integer between 0-100, |
| | | which represent the accuracy percentage |
| | | that the Auditor will aim for. A 0 means |
| | | that the system will ignore accuracy and |
| | | aims to have maximum prediction rate. |
| minimum-data-sample- | tag | Type: Integer. The minimum number of |
| size | | observed sample size that an OPPC node |
| | | must meet before it can be used for |
| | | prediction. |

Returning to the topic of the overall CDN platform, as an overlay, the CDN resources may be used to facilitate wide area network (WAN) acceleration services between enterprise data centers (which may be privately managed) and to/from third party software-as-a-service (SaaS) providers. CDN customers may subscribe to a “behind the firewall” managed service product to accelerate Intranet web applications that are hosted behind the customer's enterprise firewall, as well as to accelerate web applications that bridge between their users behind the firewall to an application hosted in the internet cloud (e.g., from a SaaS provider). To accomplish these two use cases, CDN software may execute on machines hosted in one or more customer data centers, and on machines hosted in remote “branch offices.” The CDN software executing in the customer data center typically provides service configuration, service management, service reporting, remote management access, customer SSL certificate management, as well as other functions for configured web applications. The software executing in the branch offices provides last mile web acceleration for users located there. The CDN itself typically provides CDN hardware hosted in CDN data centers to provide a gateway between the nodes running behind the customer firewall and the CDN service provider's other infrastructure (e.g., network and operations facilities). This type of managed solution provides an enterprise with the opportunity to take advantage of CDN technologies with respect to their company's intranet. This kind of solution extends acceleration for the enterprise to applications served anywhere on the Internet, such as SaaS (Software-As-A-Service) applications. By bridging an enterprise's CDN-based private overlay network with the existing CDN public internet overlay network, an end user at a remote branch office obtains an accelerated application end-to-end.

The CDN may have a variety of other features and adjunct components. For example the CDN may include a network storage subsystem (sometimes referred to herein as “NetStorage”) which may be located in a network datacenter accessible to the CDN servers, such as described in U.S. Pat. No. 7,472,178, the disclosure of which is incorporated herein by reference. The CDN may operate a server cache hierarchy to provide intermediate caching of customer content; one such cache hierarchy subsystem is described in U.S. Pat. No. 7,376,716, the disclosure of which is incorporated herein by reference. Communications between CDN servers and/or across the overlay may be enhanced or improved using techniques such as described in U.S. Pat. Nos. 6,820,133, 7,274,658, 7,660,296, the disclosures of which are incorporated herein by reference. For live streaming delivery, the CDN may include a live delivery subsystem, such as described in U.S. Pat. No. 7,296,082, and U.S. Publication No. 2011/0173345, the disclosures of which are incorporated herein by reference.

Computer Based Implementation

The clients, servers, and computer devices described herein may be implemented with conventional computer systems, as modified by the teachings hereof, with the functional characteristics described above realized in special-purpose hardware, general-purpose hardware configured by software stored therein for special purposes, or a combination thereof

Software may include one or several discrete programs. A given function may comprise part of any given module, process, execution thread, or other such programming construct. Generalizing, each function described above may be implemented as computer code, namely, as a set of computer instructions, executable in one or more microprocessors to provide a special purpose machine. The code may be executed using conventional apparatus—such as a microprocessor in a computer, digital data processing device, or other computing apparatus—as modified by the teachings hereof. In one embodiment, such software may be implemented in a programming language that runs in conjunction with a proxy on a standard Intel hardware platform running an operating system such as Linux. The functionality may be built into the proxy code, or it may be executed as an adjunct to that code.

While in some cases above a particular order of operations performed by certain embodiments is set forth, it should be understood that such order is exemplary and that they may be performed in a different order, combined, or the like. Moreover, some of the functions may be combined or shared in given instructions, program sequences, code portions, and the like. References in the specification to a given embodiment indicate that the embodiment described may include a particular feature, structure, or characteristic, but every embodiment may not necessarily include the particular feature, structure, or characteristic.

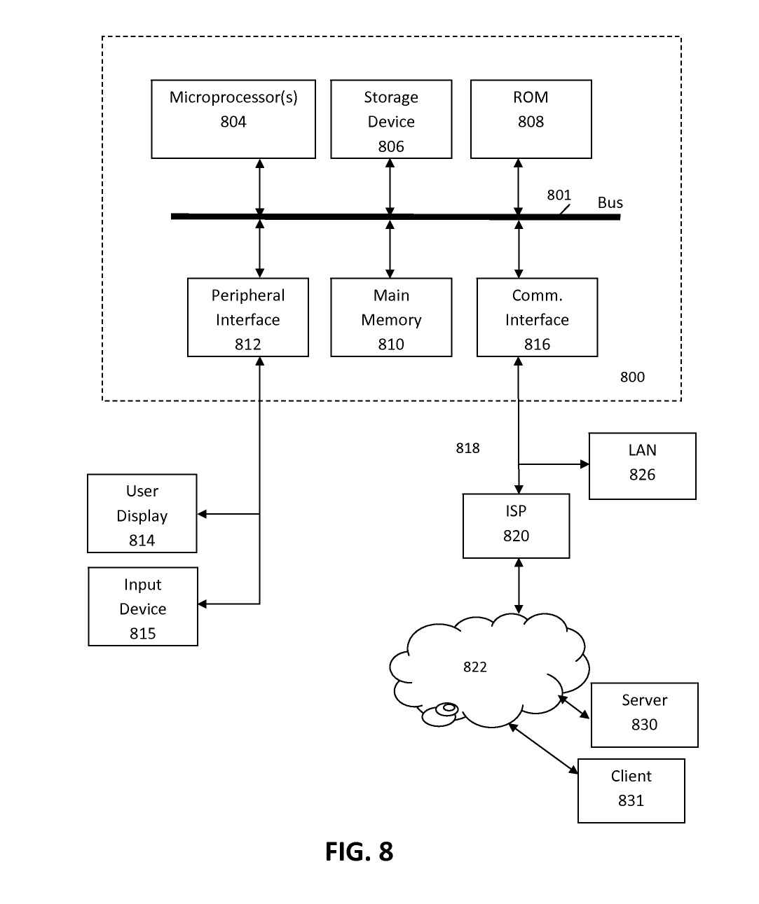

FIG. 8 is a block diagram that illustrates hardware in a computer system 800 in which embodiments of the invention may be implemented. The computer system 800 may be embodied in a client, server, personal computer, workstation, tablet computer, wireless device, mobile device, network device, router, hub, gateway, or other device.

Computer system 800 includes a microprocessor 804 coupled to bus 801. In some systems, multiple microprocessor and/or microprocessor cores may be employed. Computer system 800 further includes a main memory 810, such as a random access memory (RAM) or other storage device, coupled to the bus 801 for storing information and instructions to be executed by microprocessor 804. A read only memory (ROM) 808 is coupled to the bus 801 for storing information and instructions for microprocessor 804. As another form of memory, a non-volatile storage device 806, such as a magnetic disk, solid state memory (e.g., flash memory), or optical disk, is provided and coupled to bus 801 for storing information and instructions. Other application-specific integrated circuits (ASICs), field programmable gate arrays (FPGAs) or circuitry may be included in the computer system 800 to perform functions described herein.

Although the computer system 800 is often managed remotely via a communication interface 816, for local administration purposes the system 800 may have a peripheral interface 812 communicatively couples computer system 800 to a user display 814 that displays the output of software executing on the computer system, and an input device 815 (e.g., a keyboard, mouse, trackpad, touchscreen) that communicates user input and instructions to the computer system 800. The peripheral interface 812 may include interface circuitry and logic for local buses such as Universal Serial Bus (USB) or other communication links.

Computer system 800 is coupled to a communication interface 816 that provides a link between the system bus 801 and an external communication link. The communication interface 816 provides a network link 818. The communication interface 816 may represent an Ethernet or other network interface card (NIC), a wireless interface, modem, an optical interface, or other kind of input/output interface.

Network link 818 provides data communication through one or more networks to other devices. Such devices include other computer systems that are part of a local area network (LAN) 826. Furthermore, the network link 818 provides a link, via an internet service provider (ISP) 820, to the Internet 822. In turn, the Internet 822 may provide a link to other computing systems such as a remote server 830 and/or a remote client 831. Network link 818 and such networks may transmit data using packet-switched, circuit-switched, or other data-transmission approaches.

In operation, the computer system 800 may implement the functionality described herein as a result of the microprocessor executing code. Such code may be read from or stored on a non-transitory computer-readable medium, such as memory 810, ROM 808, or storage device 806. Other forms of non-transitory computer-readable media include disks, tapes, magnetic media, CD-ROMs, optical media, RAM, PROM, EPROM, and EEPROM. Any other non-transitory computer-readable medium may be employed. Executing code may also be read from network link 818 (e.g., following storage in an interface buffer, local memory, or other circuitry).

The client device may be a conventional desktop, laptop or other Internet-accessible machine running a web browser or other rendering engine, but as mentioned above the client may also be a mobile device. Any wireless client device may be utilized, e.g., a cellphone, pager, a personal digital assistant (PDA, e.g., with GPRS NIC), a mobile computer with a smartphone client, tablet or the like. Other mobile devices in which the technique may be practiced include any access protocol-enabled device (e.g., iOS™-based device, an Android™-based device, other mobile-OS based device, or the like) that is capable of sending and receiving data in a wireless manner using a wireless protocol. Typical wireless protocols include: WiFi, GSM/GPRS, CDMA or WiMax. These protocols implement the ISO/OSI Physical and Data Link layers (Layers 1 & 2) upon which a traditional networking stack is built, complete with IP, TCP, SSL/TLS and HTTP. The WAP (wireless access protocol) also provides a set of network communication layers (e.g., WDP, WTLS, WTP) and corresponding functionality used with GSM and CDMA wireless networks, among others.

In a representative embodiment, the mobile device is a cellular telephone that operates over GPRS (General Packet Radio Service), which is a data technology for GSM networks. Generalizing, a mobile device as used herein is a 3G—(or next generation) compliant device that includes a subscriber identity module (SIM), which is a smart card that carries subscriber-specific information, mobile equipment (e.g., radio and associated signal processing devices), a man-machine interface (MMI), and one or more interfaces to external devices (e.g., computers, PDAs, and the like). The techniques disclosed herein are not limited for use with a mobile device that uses a particular access protocol. The mobile device typically also has support for wireless local area network (WLAN) technologies, such as Wi-Fi. WLAN is based on IEEE 802.11 standards. The teachings disclosed herein are not limited to any particular mode or application layer for mobile device communications.

It should be understood that the foregoing has presented certain embodiments of the invention that should not be construed as limiting. For example, certain language, syntax, and instructions have been presented above for illustrative purposes, and they should not be construed as limiting. It is contemplated that those skilled in the art will recognize other possible implementations in view of this disclosure and in accordance with its scope and spirit.

It is noted that any trademarks appearing herein are the property of their respective owners and used for identification and descriptive purposes only, given the nature of the subject matter at issue, and not to imply endorsement or affiliation in any way.

1. An apparatus, comprising:
a machine that has circuitry forming one or more microprocessors coupled to a storage device holding computer program instructions to be executed by the one or more microprocessors, the computer program instructions including instructions that when executed cause the machine to:
receive a hypertext transfer protocol (HTTP) request for a first object from a client;
identify one or more parameters in the HTTP request for the first object, the one or more parameters including at least one of:
(i) a request header field name/value pair,
(ii) a universal resource locator (URL) query name/value pair,
(iii) a cookie name/value pair;
determine a probability of receiving an HTTP request for a second object from the client, wherein said determination is based at least in part on the presence of the one or more parameters in the HTTP request for the first object.

2. The apparatus of claim 1, wherein the one or more parameters includes a request header field name/value pair.

3. The apparatus of claim 1, wherein the one or more parameters includes a request header field name/value pair, and the request header field name/value pair comprises a user agent request header field/value pair.

4. The apparatus of claim 1, wherein the one or more parameters includes a URL query name/value pair.

5. The apparatus of claim 1, wherein the one or more parameters includes a cookie name/value pair.

6. The apparatus of claim 1, wherein the instructions when executed cause the machine to, prior to receiving a request from the client for the second object, generate a request to a source to retrieve the second object.

7. The apparatus of claim 6, wherein the source is any of: a local storage device, a remote storage device, another machine.

8. The apparatus of claim 1, wherein the instructions when executed cause the machine to generate a request to a source to retrieve the second object prior to receiving a request from the client for the second object, if the probability of receiving an HTTP request for the second object from the client exceeds a threshold.

9. The apparatus of claim 1, wherein the instructions when executed cause the machine to determine a probability of receiving a request for a third object from the client and select one of the second and third objects for prefetching by determining which of the second and third objects is associated with a higher probability.

10. The apparatus of claim 1, wherein the machine comprises an HTTP proxy.

11. The apparatus of claim 1, wherein the instructions when executed cause the machine to identify the one or more parameters in the HTTP request and generate a hash of the one or more parameters, the hash being used in determining the probability of receiving an HTTP request for the second object from the client.

12. A computer-implemented method, comprising:
receiving a hypertext transfer protocol (HTTP) request for a first object from a client;
identifying one or more parameters in the HTTP request for the first object, the one or more parameters including at least one of:
(i) a request header field name/value pair,
(ii) a universal resource locator (URL) query name/value pair,
(iii) a cookie name/value pair;
determining a probability of receiving an HTTP request for a second object from the client, wherein said determination is based at least in part on the presence of the one or more parameters in the HTTP request for the first object.

13. The apparatus of claim 11, wherein the one or more parameters includes a request header field name/value pair.

14. The apparatus of claim 11, wherein the one or more parameters includes a request header field name/value pair, and the request header field name/value pair comprises a user agent request header field/value pair.

15. The method of claim 11, wherein the one or more parameters includes a URL query name/value pair.

16. The method of claim 11, wherein the one or more parameters includes a cookie name/value pair.

17. The method of claim 11, further comprising, prior to receiving a request from the client for the second object, generating a request to a source to retrieve the second object.

18. The method of claim 17, wherein the source is any of: a local storage device, a remote storage device, another computer.

19. The method of claim 11, further comprising generating a request to a source to retrieve the second object prior to receiving a request from the client for the second object, if the probability of receiving an HTTP request for the second object from the client exceeds a threshold.

20. The method of claim 11, further comprising determining a probability of receiving a request for a third object from the client and selecting one of the second and third objects for prefetching by determining which of the second and third objects is associated with a higher probability.

21. The method of claim 11, further comprising generating a hash of the one or more parameters identified in the HTTP request, the hash being used in determining the probability of receiving an HTTP request for the second object from the client.

22. A non-transitory computer readable medium containing program instructions for execution by one or more microprocessors in a computer system, the execution of the program instructions causing the computer system to:
receive a hypertext transfer protocol (HTTP) request for a first object from a client;
identify one or more parameters in the HTTP request for the first object, the one or more parameters including at least one of:
(i) a request header field name/value pair,
(ii) a universal resource locator (URL) query name/value pair,
(iii) a cookie name/value pair;
determine a probability of receiving an HTTP request for a second object from the client, wherein said determination is based at least in part on the presence of the one or more parameters in the HTTP request for the first object.

23. An apparatus, comprising:
a machine that has circuitry forming one or more microprocessors coupled to a storage device holding computer program instructions to be executed by the one or more microprocessors, the computer program instructions including instructions that when executed cause the machine to:
receive a hypertext transfer protocol (HTTP) request for a first object, the first object being identified by a universal resource locator (URL);
identify one or more parameters in the HTTP request for the first object other than a protocol, hostname, or path of the URL;
determine a probability of receiving an HTTP request for a second object from the client, wherein said determination comprises:
(i) determining a probability of receiving an HTTP request for the second object, given the URL or a portion thereof;
(ii) determining a marginal probability for each of the one or more parameters as an independent event;
(iii) for each marginal probability determined in (ii), adjusting the probability determined in step (i).

24. The apparatus of claim 23, wherein each of the marginal probabilities for the one or more parameters are either positive or negative and lead to positive or negative adjustments, respectively, in step (iii).

25. The apparatus of claim 23, wherein the one or more parameters include at least one of:
(a) a request header field name/value pair, and
(b) a URL query name/value pair;
(c) a cookie name/value pair.

26. The apparatus of claim 23, wherein the instructions when executed cause the machine to, prior to receiving a request from the client for the second object, generate a request to a source to retrieve the second object.

27. The apparatus of claim 26, wherein the source is any of: a local storage device, a remote storage device, another machine.

28. The apparatus of claim 23, wherein the instructions when executed cause the machine to generate a request to a source to retrieve the second object prior to receiving a request from the client for the second object, if the probability of receiving an HTTP request for the second object exceeds a threshold.

29. The apparatus of claim 23, wherein the instructions when executed cause the machine to determine a probability of receiving an HTTP request for a third object from the client and to select one of the second and third objects for prefetching by determining which of the second and third objects is associated with a higher probability.

30. A computer-implemented method, comprising:
receiving a hypertext transfer protocol (HTTP) request for a first object, the first object being identified by a universal resource locator (URL);
identifying one or more parameters in the HTTP request for the first object other than a protocol, hostname, or path of the URL;
determining a probability of receiving an HTTP request for a second object from the client, wherein said determination comprises:
(i) determining a probability of receiving an HTTP request for the second object, given the URL or a portion thereof;
(ii) determining a marginal probability for each of the one or more parameters as an independent event;
(iii) for each marginal probability determined in (ii), adjusting the probability determined in step (i).

31. The method of claim 30, wherein each of the marginal probabilities for the one or more parameters are either positive or negative and lead to positive or negative adjustments, respectively, in step (iii).

32. The method of claim 30, wherein the one or more parameters include at least one of:
(a) a request header field name/value pair, and
(b) a URL query name/value pair;
(c) a cookie name/value pair.

33. The method of claim 30, further comprising, prior to receiving a request from the client for the second object, generating a request to a source to retrieve the second object.

34. The method of claim 33, wherein the source is any of: a local storage device, a remote storage device, another machine.

35. The method of claim 30, further comprising generating a request to a source to retrieve the second object prior to receiving a request from the client for the second object, if the probability of receiving an HTTP request for the second object exceeds a threshold.

36. The method of claim 30, further comprising determining a probability of receiving an HTTP request for a third object from the client and selecting one of the second and third objects for prefetching by determining which of the second and third objects is associated with a higher probability.

37. A non-transitory computer readable medium containing program instructions for execution by one or more microprocessors in a computer system, the execution of the program instructions causing the computer system to:
receive a hypertext transfer protocol (HTTP) request for a first object, the first object being identified by a universal resource locator (URL);
identify one or more parameters in the HTTP request for the first object, the one or more parameters not including a protocol, hostname, or path of the URL;
determine a probability of receiving an HTTP request for a second object from the client, wherein said determination comprises:
(i) determining a probability of receiving an HTTP request for the second object, given the URL or a portion thereof;
(ii) determining a marginal probability for each of the one or more parameters as an independent event;
(iii) for each marginal probability determined in (ii), adjusting the probability determined in step (i).
